(19) United States
(12) Patent Application Publication
(10) Pub. No.: US 2008/0241319 A1
(43) Pub. Date: Oct. 2, 2008

(54) Novel protein layering masses, processes for the manufacture thereof, and related products

(76) Inventors: Pramod K. Pandey, Pointe Claire (CA); Edward Hanneman, Verdun (CA)

Correspondence Address: ARENT FOX LLP, 1050 CONNECTICUT AVENUE, N.W., SUITE 400, WASHINGTON, DC, 20036, US

(21) Appl. No.: 12/000,266

(22) Filed: Dec. 11, 2007

Related U.S. Application Data
(63) Continuation of application No. 10/592,322, now abandoned.
(60) Provisional application No. 60/552,437, filed on Mar. 12, 2004.

(51) Int. Cl. A23P 1/08; A23L 1/48; A23L 1/05; A23L 1/0532; A23L 1/0562; A23L 1/0524; A23C 9/16; A23P 1/10; A23L 1/0522; A23L 1/22; A23L 1/302; A23D 7/00

(52) U.S. Cl. 426/72; 426/656; 426/573; 426/575; 426/577; 426/578; 426/576; 426/650; 426/601; 426/103; 426/96; 426/588; 426/274; 426/512

(57) ABSTRACT

A layering mass comprising protein and carbohydrate, where between 10% and 55% by weight of the layering mass is protein, is described together with methods of making the same. Also described are confectionery type bars and nutritional bars comprising the confectionery layering material of the present invention.

### CROSS REFERENCE TO RELATED APPLICATIONS

This application claims the benefit of priority to U.S. Provisional application No. 60/552,437, filed Mar. 12, 2004, which applicants herein incorporate by reference in its entirety.

### BACKGROUND OF THE INVENTION

1. Field of the Invention

The present invention relates to layering masses useful in products made using confectionery processes.

2. Description of the Related Art

The invention relates to masses comprising protein and carbohydrate that can be used as, and are generally described as, “layering masses” or “layering materials.” A layering mass is a substance that can be subjected to a forming process such as rolling, extrusion through slits or slots, depositing and removal from refrigerated drums, slabbing between two temperature-controlled drums, pressing between plates, insertion into molds, or combinations of the foregoing. These layering masses can then be applied to a separately formed or shaped material, which may have been formed in a similar fashion, to give a product that consists of two or more layers. A typical utility for such a layered product is as a nutritional or candy bar. The motivation to manufacture such layered products may be one or more of the following: to introduce pleasing variation or variations in taste, appearance or texture as a consequence of the contrasts with other components of the confectionery product, to act as a carrier for some ingredient of functional or nutritional importance where such ingredient for technical or organoleptic (i.e. relating to perception by a sensory organ, such as taste, smell or feel) reasons might be unsuitable for use in other components of the confectionery product, or to take advantage of some manufacturing technique which might bestow a unique combination of properties on the resultant two- or multi-layered confectionery product.

One example of a layering mass or layering material is caramel, which may be manufactured by heating mixtures of milk products (such as milk, cream or milk proteins) with carbohydrates (such as sugar) and fat. At temperatures in the range of 93° C. to 150° C., the milk proteins react with the other ingredients, particularly the carbohydrate, to give the typical flavor, texture and color of caramel or toffee. The texture and firmness of such traditional caramels are determined by the final cook temperature, together with the specific ingredients used in the mix, while the flavor and color are due to the specific ingredients and the order of addition of these ingredients to the mix. Another example of a layering mass would be a gelled fruit preparation generally known as a fruit filling, though conventional fruit fillings often present technical obstacles in the manufacture of multi-layered confectionery products. Further examples, which are not limiting, would include any confectionery mass that may be used as a layering mass or material, such as creams, taffy, fondants, fudges, marshmallow, nougat, gummy layering materials and jellies.

Conventional confectionery layering masses or materials as described above, though often of excellent organoleptic properties when considered as stand-alone products, may be inappropriate nutritionally for incorporation into confectionery products that are medical or nutritional foods, such as nutrition bars. For example, such conventional materials are high in carbohydrate, and low in protein, and their use in multilayered products at sufficient levels to ensure an organoleptic advantage will downgrade the nutritional profile of the final product such that it may become unacceptably high in carbohydrate or low in protein. Since in many areas of nutrition, for example, the nutritional treatment of obesity, the emphasis is on high protein and low carbohydrate intakes, multilayered confectionery products derived from classical manufacturing processes find no application, and the choice of products for those placed on high protein, low carbohydrate diets is limited.

U.S. Pat. No. 5,384,148 teaches the manufacture of caramels containing milk proteins, but the source of the milk proteins disclosed in that patent is milk products and milk solids derived from whole milk or whey in liquid, condensed or in dry form, thus not the isolated proteins of the instant invention. Furthermore, the caramel disclosed in U.S. Pat. No. 5,384,148 is a hard or brittle caramel for use as a coating or a standalone product with crunchy consistency, and while the specification does not reveal the protein content of the caramels, an appraisal of the specification and examples suggests that this is inferior to the 10% minimum level of the instant invention.

The novel confectionery layering masses of the present invention thus provide nutritional options which have hitherto not been available, in that they permit the manufacture of multilayered confectionery products in the form of nutritional bars, which despite their multi-layered aspect are richer in protein and lower in carbohydrate.

### BRIEF DESCRIPTION OF THE DRAWINGS

FIG. 1 is an illustration of a machine capable of making slabs in confectionery processes wherein the slabs may comprise one or more layers.

FIG. 2 is an illustration of a continuous mixer.

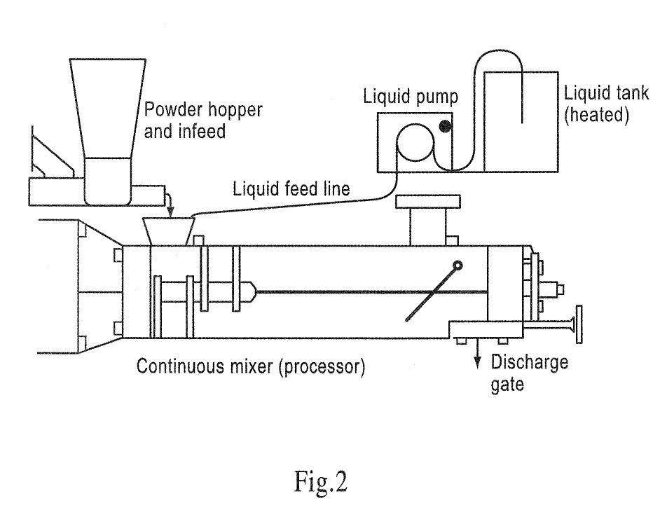

### SUMMARY OF THE INVENTION

In one embodiment, the invention relates to a homogenous layering mass comprising carbohydrate and protein, wherein 10% to 55% by weight of the layering mass is protein, wherein the protein is in non-particulate form and uniformly dispersed throughout the mass; wherein said carbohydrate is in the form of a concentrated liquid or in dry form with the addition of water; and wherein the layering mass is a flowable, viscous liquid at temperatures of 40° C. or above but is non-flowable, with good stand-up behavior at temperatures of 30° C. or less.

In other embodiments, the above layering mass may comprise 10% to 50% by weight of the protein, 10% to 45% by weight of the protein or 20% to 45% by weight of the protein.

In yet another embodiment, the layering mass of the invention comprises fruit and a gelling agent. Such gelling agent may be pectin, alginate, starch, agar-agar, gelatine or mixtures thereof. The fruit may be fresh fruit, dried fruit, fruit puree, powdered fruit, concentrated fruit, partially dried fruit, glacéed fruit or combinations thereof.

The protein in the layering mass of the invention may be a whey protein concentrate, a whey protein isolate, caseinate, wheat protein, casein, gelatine, soy protein, pea protein, rice protein, canola protein or mixtures thereof. In one embodiment, the protein is whey protein in which up to 50% of the protein is hydrolyzed.

The carbohydrate in the layering mass of the invention may be partially or wholly a sugar alcohol, wherein the sugar alcohol is selected from the group consisting of glycerine, sorbitol, maltitol, lactitol, hydrogenated starch hydrolysate, erythritol, xylitol, arabinitol, galactitol, isomaltitol, palatinit, mannitol ribitol and mixtures thereof.

The layering mass of the invention may further comprise other ingredients such as a preservatives, flavors, colors, proteins in particulate form, vitamins, minerals, nutritional additives or combinations thereof.

In one embodiment, the layering mass of the invention is caramel. The protein in such caramel may be selected from the group consisting of a whey protein concentrate, a whey protein isolate, caseinate, wheat protein, casein, gelatine, soy protein, pea protein or mixtures thereof. In one embodiment, the protein is whey protein in which up to 50% of the protein is hydrolyzed. The caramel of the invention may further contain one or more of oil or fat, nuts, seeds, legumes, lecithin, flavor, preservatives, nutritional additives or color. In another embodiment, the caramel layering mass of the invention comprises deamidated wheat protein. In another embodiment, the caramel layering mass of the invention comprises 18% to 35% by weight of protein.

In another embodiment, the layering mass of the invention is a material selected from the group consisting of creams, taffy, fondants, fudges, marshmallow, nougat, gummy layering materials and jellies. Such layering masses would be homogenous and comprising carbohydrate and protein, wherein 10% to 55% by weight of the layering mass is protein, wherein the protein is in non-particulate form and uniformly dispersed throughout the mass; wherein said carbohydrate is in the form of a concentrated liquid or in dry form with the addition of water; and wherein the layering mass is a flowable, viscous liquid at temperatures of 40° C. or above but is non-flowable, with good stand-up behavior at temperatures of 30° C. or less.

The layering mass of the invention may be in the form of a bar. Such bar may be a nutritional bar. The bar may be a bite-sized bar or a regular sized bar that may or may not be enrobed in a coating. Such bar may comprise at least two layers of confectionery mass, wherein at least one of the layers is a conventional confectionery mass and at least one of the layers is the layering mass of the invention. Coating materials for the bars of the invention include flavored fat, flavored sugar, chocolate, white chocolate, compound chocolate, yoghurt-flavored coatings, white confectionery coatings, and carob-based coating. Fats for coatings include cocoa butter, cocoa butter equivalents, or cocoa butter substitutes. Generally, fat comprises hardened or fractionated vegetable oils. In one embodiment, at least 20% of the total weight of the coating is fat and the coating further comprises at least one other ingredient such as cocoa powder, chocolate liquor, yoghurt powder, carob powder, carbohydrates, emulsifiers or flavors.

In one embodiment, the layering mass of the invention comprises maltitol syrup, soybean oil, glycerine, sorbitol syrup, flavors, soy lecithin, sucralose solution, mixed tocopherols, gelatine, whey protein concentrate, and calcium caseinate.

In another embodiment, the layering mass of the invention comprises gelatine, glycerine, maltitol syrup, monglycerides, sucralose solution, water, flavor, calcium carbonatR, mixed tocopherols, soy protein isolate, acid casein, whey protein isolate, gelatine, cocoa powder, calcium caseinate, milk minerals, vitamins, magnesium oxide, and fat.

In another embodiment, the layering mass of the invention comprises acid casein, whey protein isolate, gelatine, soy protein concentrate, cocoa, calcium caseinate, milk minerals, vitamins, minerals, flavor, magnesium oxide, magnasweet, glycerine, maltitol syrup, fat, chocolate liquor, water, monoglycerides, calcium carbonate, sucralose, and tocopherols.

In another embodiment, the layering mass of the invention comprises maltitol syrup, strawberry juice concentrate, sugar, glycerine sorbitol, water, palm kernel oil, pectin sodium citrate, sucrolose flavor, lecithin color, whey protein isolate, citric acid, and monoglycerides.

In another embodiment, the layering mass of the invention comprises water, hydrogenated palm kernel oil, calcium caseinate, whey protein isolate, soya lecithin, maltitol syrup, oligofructose and glyceryl monostearate.

In another embodiment, the layering mass of the invention comprises water, skim milk powder, fractionated palm kernel oil, soya lecithin, corn syrup, granulated sugar, glyceryl monostearate, and flavor.

In another embodiment, the layering mass of the invention comprises gelatine, glycerine, maltitol syrup, flavor, monoglycerides, diglycerides, tocopherols, water, sucralose, acid casein, whey protein isolate, soy protein concentrate, calcium caseinate, fat, milk mineral concentrate, vitamins, minerals, magnesium oxide and licorice root extract.

In another embodiment, the layering mass of the invention comprises water, whey protein isolate, monoglycerides, lecithin, tocopherols, soybean oil, maltitol syrup, glycerol, sorbitol syrup, flavor, caramel color, whey protein concentrate, apple powder, soy protein isolate, and malic acid.

The invention also relates to a method of making a layering mass, the method comprising the steps of:
(a) combining non-particulate protein and carbohydrate to form a mass;
(b) mixing the mass so as to uniformly disperse the protein throughout the mass; and
(c) maintaining the internal temperature of the mass at a temperature such that the mass is in a viscous, flowable state capable of forming a layer;
   wherein at least 10% to 55% by weight of the layering mass is protein and wherein said carbohydrate is in liquid concentrated form or is in dry form mixed with water. This method further comprises lowering the internal temperature of the product of part (c) so as to produce a mass that is non-flowable and has good stand-up behavior. In order to form a viscous, flowable mass the internal temperature of part (c) should be at least 40° C.

Another embodiment of the invention relates to a method of making a bar comprising the steps of:
(a) providing the layering mass of the invention;
(b) providing a conventional confectionery mass;
(c) forming a slab from the layering mass;
(d) forming a slab from the conventional confectionery mass;
(e) layering the layering mass slab on the conventional confectionery slab; and
(f) cutting said layered slabs into a bar.

In another embodiment, the invention relates to a method of making a bar comprising the steps of:
(a) providing an above described layering mass;
(b) forming a slab from (a);
(c) cutting the slab of (b) into a bar.

The above described methods of making a bar may further comprise enrobing the such bar in a coating.

### DETAILED DESCRIPTION OF THE INVENTION

Thus, the present invention relates to a homogenous layering mass comprising carbohydrate and protein, wherein 10% to 55% by weight of the layering mass is protein, wherein the protein is in non-particulate form and uniformly dispersed throughout the mass; wherein said carbohydrate is in the form of a concentrated liquid or in dry form with the addition of water; and wherein the layering mass is a flowable, viscous liquid at temperatures of 40° C. or above but is non-flowable and with good stand-up behavior at temperatures of 30° C. or less.

“Homogenous” means the condition wherein the components are uniformly diffused or dispersed throughout and the mass presents in a uniform visual appearance and texture and of uniform density throughout without small or large areas of different appearance, composition or density.

“Viscous” means the condition wherein the layering mass is thick, and flows slowly in comparison to water. Viscosity is the property of a fluid that resists the force tending to cause the fluid to flow. When the resistance equals or exceeds the force, the fluid ceases to flow and becomes non-flowable. This definition applies to normal conditions, i.e. normal pressures. Even solids will flow under very high pressures, such as, for example, aluminium which is shaped by ultra-high pressure extrusion.

“Flowable” means the condition in which the mass is capable of flowing like a liquid; not capable of maintaining a shape when not physically confined. Another property similar to “viscous and flowable” is “viscoelastic”. A true fluid flows when it is subjected to a shear field and motion ceases as soon as the stress is removed. In contrast, an ideal solid subjected to stress recovers its original state as soon as the stress is removed. Some materials exhibit “viscoelastic” characteristics having some of the properties of both a solid and a liquid. Two examples of viscoelastic behavior are: (1) The liquid in a cylindrical vessel is given a swirling motion by means of a stirrer. When the stirring is stopped, the fluid gradually comes to a rest and, if viscoelastic, may then start to rotate in the opposite direction (i.e. to unwind). (2) A viscoelastic fluid, on emerging from a tube or a die, may form a jet which is of larger diameter than the aperature. The phenomenon is referred to as “die-swell” and results from the sudden removal of a constraining force on the fluid. Viscoelastic fluids are thus capable of exerting normal stresses.

“Non-flowable” means the layering mass maintains its shape for prolonged periods when not physically confined. “Good stand-up behavior” means the layering mass maintains the shape into which it has been formed or cut, shows little or no distortion in shape when cut with sharp knives or guillotines, may recover from minor distortions when the agent responsible for the distortion (such as a knife) has been removed. Another property similar to “non-flowable and with good stand-up” behavior is “thermoplastic.” Thermoplastic materials are polymers that can be softened by the application of heat and then reharden on cooling, a sequence that can be repeated any number of times, subject to possible chemical degradation of the material, depending on the specific polymer. Thermosetting materials are polymeric substances that similarly soften on heating but undergo an irreversible chemical change at elevated temperatures, manifested by hardening. Once a thermosetting material has been heated to its curing temperature, the hardening process goes on and there is not turning back.

“Particulate form” means in the form of particles or pieces which are at least visible to the naked eye or larger.

According to the invention, temperatures are measured using means known to those of skill in the art of the invention. For instance, temperature may be measured by thermometers or probes inserted into the material and the surface temperature may be determined by remote-sensing equipment such as infra-red sensors.

The layering mass of the present invention is a type of “confectionery mass,” i.e. a mass that may be formed or molded by a confectionery process to give a defined and cohesive shape or layer. Various confectionery processes are known to the skilled artisan. Within the context of the present invention, a “conventional confectionery mass,” means a dough that may be used to make a conventional bar or nutrition bar, that is made by the process described below.

That is, in the process of manufacturing a confectionery or nutritional bar, cold forming or extrusion is used. Other types of extrusion processes are used in the food industry, and it is necessary to clearly demarcate the differences between the cold forming or extrusion used in the manufacture of confectionery type bars, and the process of cooking extrusion used in the manufacture of other types of shaped or formed food objects, since both are often referred to as “extrusion.”

In the process of cold forming/extrusion, the required mix consists of a blend of powders, some or all of which are capable of absorbing water (moisture) or otherwise hydrating, and concentrated solutions of various other ingredients, such as the carbohydrate. The powders absorb water from the concentrated solutions and the individual ingredients in the powder part of the mixture then hydrate. The hydrated molecules (which are generally proteins or complex carbohydrates such as starches) then exhibit affinity through the formation of weak intermolecular forces which can be electrostatic in nature, and can include bonds such as hydrogen bonds as well as van der Waals forces. The carbohydrate (or other) constituent of the original liquid remains entrained in the complex of hydrated molecules, as may other materials (such as fats) that are added to the mixture. A measure of the emulsifying power of the hydrated molecules is needed to see how much fat or oil can be thus entrained or coated with protein, since the hydrophobic nature of fat or oil makes greater demands on the strength of interaction between the hydrated molecules.

It is equally possible, though less desirable, to mix the hydrateable materials and the carbohydrate (or other) constituents and then add water. The quality and integrity of product thus produced may be inferior due to poor dispersion. Addition of water alone to hydrateable protein gives a mass that lacks adequate integrity and cohesion and is not suitable for cold forming; this limitation is not necessarily present for hydrateable carbohydrates.

The process above is intended to give a plastic mass which can then be shaped, without further physical or chemical changes occurring, by the procedure known as cold forming or extrusion. In this process, the plastic mass is forced at relatively low pressure through a die which confers the desired shape and the resultant extrudate is then cut off at an appropriate position to give products of the desired weight.

The mass may, for example, be forced through a die of small cross-section to form a ribbon, which is carried on a belt moving at a predetermined speed under a guillotine type cutter which operates at regular intervals. The cutter, in this case, generally consists of a sharpened blade so adjusted that it cuts through the ribbon but not the underlying belt, but may also consist of a wire. In both cases, the principle is the same; the cutting process occurs at intervals that permit the moving ribbon to be cut into pieces of equivalent weight and dimensions. Generally, this is achieved by timing the cutting strokes and maintaining belt speed at an appropriate level, but there also exist computer controlled versions of this mechanism which offer greater versatility. Alternatively, the mass may be forced through a die of large cross-section and the cut at die level into slices by an oscillating knife or wire, which drop onto a moving belt and are thus transported away. The mass may also be extruded as a sheet, which is then cut with a stamp type cutter into shapes that are appropriate, such as a cookie type cutter. Finally, the mass may also be forced into chambers on a rotary die equipped with an eccentric cam that forces the thus-formed material out of the chamber at a certain point in the rotation of the cylindrical die.

After shaping, the formed product is moved by a transfer belt or other type of material conveyor to an area where it may be further processed or simply packaged. In general, a nutritional bar of the type described would be enrobed (coated) in a material that may be chocolate, a compound chocolate coating, or some other type of coating material. In all such cases, the coating material consists of a fat that is solid at room temperature, but that is liquid at temperatures in excess of, e.g., 88° F., together with other materials that confer the organoleptic attributes. The coating is thus applied to the bar while molten, by permitting the bar to pass through a falling curtain of liquid coating, at the same time passing over a plate or rollers which permit coating to be applied to the under surface of the bar, and excess coating is blown off by means of air jets, Finally, the enrobed bar passes through a cooling tunnel where refrigerated air currents remove heat and cause the coating to solidify.

In all these variations, the requirement is that the plastic mass be relatively soft, possessed of sufficient integrity to maintain its form after shaping.

The process of cold forming, often ambiguously referred to as “extrusion”, is thus a distinct process, with the characteristics described below:

1) Low temperature. Generally, the process occurs at ambient temperature of 60° F. to 85° F., though in some cases it is desirable to cool the extrusion equipment down to lower temperatures, and occasionally, when manufacturing products based on sucrose, or nutritional products of similar physical characteristics, the extruder may be heated to temperatures in excess of 100° F. However, for the manufacture of nutritional products, temperatures are usually kept at ambient or occasionally slightly lower.

2) Low pressure. Pressure is required only to force the mass through the die, and pressure in the die will generally remain below 60 lbs./sq. inch.

3) Reliance on the physical properties of the mass fed to the extruder to give the final form to the product.

4) Absence of heat- or pressure-mediated chemical or physical reactions or changes; the only changes occurring in the product are those caused by hydration during the initial mixing procedure.

Thus, the present invention is directed to a layering mass, which is a type of confectionery mass capable of being shaped into a sheet or slab, as described above. However, the layering mass of the invention comprises protein and carbohydrate wherein 10% to 55% by weight of the mass is protein and wherein the carbohydrate is digestible, poorly digestible or mixtures of digestible and poorly digestible carbohydrate and wherein the carbohydrate is in the form of a concentrated liquid or is dry and mixed with water. In one embodiment, 10% to 45% by weight of the mass is protein, in another embodiment, 20% to 45% by weight of the layering mass is protein.

The confectionery mass of the invention may be fruit-based and comprising fruit and a gelling agent, such as pectin, alginate, starch, agar-agar, gelatine and mixtures thereof. In this embodiment, about 10% to 50% by weight of the mass is protein; in another, about 20% to 45% by weight of the mass is protein. Fruit may be fresh fruit, dried fruit, fruit puree, powdered fruit, concentrated fruit, partially dried fruit, glacéed fruit or combinations thereof. In the fruit-based confectionery mass, the protein is preferably a whey protein concentrate, a whey protein isolate or concentrate, milk protein isolate or concentrate, caseinate, casein, gelatine, soy protein, pea protein, rice protein, wheat protein and combinations thereof. Part or all of the protein system may be hydrolyzed to a greater or lesser extent in order to obtain the desired viscoelastic properties of the finished layering masses.

Preferably, from 10-50% of the available protein is hydrolyzed although greater degrees of hydrolysis are possible as long as acceptable organoleptic properties are maintained. Use of hydrolyzed or partially hydrolyzed protein maintains the desirable flow characteristics of the layering mass, and confers unique properties on the layering material for handling and movement of the layering masses from mixing stage to slabbing stage. The unique flow characteristics of the layering masses enable uniform slab formation. The flow characteristics of the layering masses is a function of temperature. After cooling the layered material acquires better stand-up characteristics just before enrobing, which controls the cold flow or leakage of bars after coating.

In one embodiment, the layering mass of the invention comprises a carbohydrate that is partially or wholly a sugar alcohol. That is, the sugar alcohol could be an alcohol of any sugar known to the skilled artisan. Examples of such sugar alcohols include, but are not limited to, glycerine, sorbitol, maltitol, lactitol, hydrogenated starch hydrolysate, erythritol, xylitol, arabinitol, galactitol, isomaltitol, palatinit, mannitol, ribitol and mixtures thereof. The sugar alcohols may be in the form of powders, crystals or of concentrated solutions otherwise referred to as syrups.

In another embodiment, the layering mass of the invention comprises carbohydrates which include completely or partly sugar-based carbohydrates, mono-, di- and polysaccharides, including, but not limited to, fructose, glucose (dextrose) and sucrose, and/or soluble fibers, including, but not limited to, fructooligosaccharides. These carbohydrates may be in the form of powders, crystals or of concentrated solutions otherwise referred to as syrups. The confectionery mass of the invention may also contain flavor, color, protein pieces, nutritional additives, vitamins, minerals, preservatives and mixtures thereof.

In another embodiment, the layering mass of the invention is caramel, which may or may not comprise an oil or fat. The caramel confectionery mass of the invention may comprise about 18 to about 35% by weight of protein. In one embodiment, the caramel comprises deamidated wheat protein. Other suitable proteins are casein, caseinate, soy and pea protein. This embodiment may further comprise nuts, seeds, legumes, lecithin, flavor, preservatives, nutritional additives and color and any other ingredients typically found in caramels.

The layering mass of the invention may also contain particulates, including, but not limited to fruit pieces, cookie pieces, crisp materials such as crisp rice or expanded puffed soy products, flavor bits, and mixtures thereof.

The layering mass of the invention may be in the form of one or more layers and may be a confectionery product.

In one embodiment, the confectionery product is a bar. In another, the confectionery product is bite-sized. In another, the confectionery product is a nutritional bar. A confectionery product according to the invention may have more than one layer and such layers may be different from each other. For instance, in one embodiment, one of the layers may be caramel while other layers may be a non-caramel confectionery mass, such as a fruit based mass or other layering material. One layer may be from the layering mass according to the invention, wherein another layer may be a conventional confectionery mass layer that is not a layering mass according to the invention.

The confectionery product of the invention may be enrobed in a coating material. Coating materials include, but are not limited to, flavored fat, flavored sugar, chocolate, white chocolate, compound chocolate or yoghurt-flavored coatings, white confectionery coatings, and carob-based coatings, wherein the fat may comprise cocoa butter, cocoa butter equivalents, or cocoa butter substitutes such as hardened or fractionated vegetable oils.

In one embodiment, the confectionery mass of the invention comprises maltitol syrup, soybean oil, glycerine, sorbitol syrup, flavors, soy lecithin, sucralose solution, mixed tocopherols, hydrolyzed gelatine, whey protein concentrate (partially hydrolyzed), and calcium caseinate.

In another embodiment, the confectionery mass of the invention comprises gelatine (hydrolyzed), glycerine, maltitol syrup, monglycerides, sucralose solution, water, flavor, calcium carbonate, mixed tocopherols, soy protein isolate (partially hydrolyzed), acid casein, whey protein isolate, whey protein isolate (partially hydrolyzed) and/or whey protein concentrate (partially hydrolyzed), cocoa powder, calcium caseinate, milk minerals, vitamins, magnesium oxide, and fat.

In another embodiment, the confectionery mass of the invention comprises acid casein, whey protein isolate, gelatine (hydrolyzed), soy protein concentrate, cocoa, calcium caseinate, milk minerals, vitamins, minerals, flavor, magnesium oxide, glycerine, maltitol syrup, fat, chocolate liquor, water, monoglycerides, calcium carbonate, sucralose, and tocopherols.

In another embodiment, the confectionery mass of the invention, comprises maltitol syrup, strawberry juice concentrate, sugar, glycerine sorbitol, water, palm kernel oil, pectin sodium citrate, sucrolose flavor, lecithin color, whey protein isolate and/or other milk proteins and/or vegetable protein (hydrolyzed or non hydrolyzed), citric acid, and monoglycerides.

In another embodiment, the confectionery mass of the invention comprises water, hydrogenated or fractionated palm kernel oil, calcium caseinate, whey protein isolate and/or partially hydrolyzed whey protein isolate or concentrate, soya lecithin, maltitol syrup, oligofructose and glyceryl monostearate.

In another embodiment, the confectionery mass of the invention comprises hydrolyzed gelatine, glycerine, maltitol syrup, flavor, monoglycerides, diglycerides, tocopherols, water, sucralose, acid casein, whey protein isolate and/or whey protein isolate or concentrate (partially hydrolyzed), soy protein concentrate, calcium caseinate, fat, milk mineral concentrate, vitamins, minerals, magnesium oxide and licorice root extract.

In another embodiment, the confectionery mass of the invention comprises water, whey protein isolate and/or whey protein isolate (partially hydrolyzed), monoglycerides, lecithin, tocopherols, soybean oil, maltitol syrup, glycerol, sorbitol syrup, flavor, caramel color, whey protein concentrate (partially hydrolyzed), apple powder, soy protein isolate, and malic acid.

In another embodiment, the invention relates to a method of making a layering mass, the method comprising the steps of:
(a) combining protein and carbohydrate to form a mass;
(b) mixing the mass so as to uniformly disperse the protein throughout the mass; and
(c) maintaining the internal temperature of the mass at a temperature such that the mass is in a viscous, flowable state capable of forming a layer;
   wherein at least 10% to 55% by weight of the layering mass is protein and wherein said carbohydrate is in liquid concentrated form or is in dry form mixed with water. This method may further comprise lowering the internal temperature of the product of part (c) so as to produce a mass that is non-flowable and has good stand-up behavior. In the above method, the internal temperature of part (c) is at least 40° C. so as to maintain a viscous, flowable mass.

This method may further comprise forming a slab from the confectionery mass and optionally combining such slab with slabs formed from other, confectionery masses. In this method, the confectionery mass is produced in one embodiment by incorporating protein blend into a liquid comprising carbohydrate at a temperature in the range of 40 to 70 degrees centigrade. Thus, in one embodiment, the invention relates to a method of making a bar comprising the steps of
(a) providing the layering mass of the invention as described above;
(b) providing a conventional confectionery mass;
(c) forming a slab from said layering mass;
(d) forming a slab from said conventional confectionery mass;
(e) layering said layering mass slab on said conventional confectionery slab; and
(f) cutting said layered slabs into a bar.

In another embodiment, the method of making a bar comprises the steps of:
(a) providing the layering mass of the invention;
(b) forming a slab from (a);
(c) cutting the slab of (b) into a bar.

Any bar according to the present invention can be enrobed in a coating.

Thus, the present invention provides novel soft, chewable and pliable confectionery masses, rich in protein and capable of being shaped or formed into sheets or slabs which can be combined with other such layers or confectionery layers of more conventional nature to give confectionery products in the form of bars that consist of two or more layers, the resultant bars being masticable, organoleptic and of significant nutritional value. Preferably, at least 15% of the calculated energy content of the product is derived from protein.

The confectionery masses of the invention also may be used alone to manufacture the cores of bars which are subsequently enrobed in a coating material such as chocolate or a compound coating, but their main utility is in the manufacture of layered bars.

The confectionery masses of the invention comprise at least 10% protein by weight, where the protein may consist of, but is not limited to, those proteins known as whey protein isolates and concentrates, hydrolysed whey protein isolates and concentrates in which from about 10-50% of the available protein has been partially or fully hydrolysed, casein and caseinates, e.g. calcium/sodium/potassium/magnesium caseinate etc., and hydrolysed gelatine (hydrolysed collagen), as well as mixtures thereof. They may optionally also contain gelatine that has not been hydrolysed for functional or technical reasons. The protein of the invention also may be wheat, rice, soy or pea protein. The novel masses according to the invention are made by combining the protein with the base of the confectionery mass and mixing under appropriate and specific conditions for a certain period of time and at a temperature in the range of about 40° C. to about 70° C. until the correct texture is obtained, whereby the configuration of the mixing device, the time of mixing and the temperature to be attained are specific to the composition of the resultant novel confectionery mass.

The “base” of the confectionery mass to be combined with the protein may be of conventional nature. For example, the typical layering materials referenced above may be used as a base. Such bases may further contain a variety of other ingredients, for example, in a caramel base comprising water, carbohydrate, oil and flavor, the carbohydrate may be a simple sugar or a polymer thereof, used in either dry form or as a concentrated liquid, such as a mono- or di-saccharide, or a tri-, tetra- or polysaccharide, a sugar alcohol or polymer thereof, such as sorbitol, maltitol, lactitol or hydrogenated dextrins or starch, random polymers of simple sugars such as polydextrose or oligofructose, including mixtures of any of the indicated carbohydrates, wherein the carbohydrate may be incorporated in dry form or as a concentrated liquid, and wherein said caramel base may contain milk proteins or other proteins as well as such other ingredients, such as oil or fat, as may conventionally be used in caramels and will be obvious to a skilled artisan, and also ingredients such as nuts, seeds, legumes or pieces thereof, including ground or milled nuts, seeds or legumes. The oil may consist of any edible oil or fat, including ingredients rich in fat such as chocolate liquor, chocolate, peanut butter, almond butter or other ground high-fat oil-seeds or oil nuts. Such a caramel base may further include mono- or diglycerides, salt or other physiologically acceptable inorganic substances, lecithin, such as soya lecithin, and flavors such as natural vanilla flavor. The caramel may further include a wheat protein, such as a deamidated wheat gluten, in accordance with the teachings of International Patent Application PCT/US03/02705 (WO 03/068000), which is herein incorporated wholly by reference.

A fruit filling base may contain fruit, optionally crushed, and pectin, but may also contain additional ingredients obvious to the skilled artisan, including, but not limited to, citric acid, sodium citrate, calcium citrate, phosphates, carbohydrates in the broadest sense of the word, including sugar, fructose, glucose (dextrose), other mono- and disaccharides, sugar alcohols such as glycerine, sorbitol, maltitol, xylitol and the like, gums, fibers, alginates, colors, flavors, salt, emulsifiers and preservatives such as benzoates and sorbates. The crushed fruit of the puree may be selected from the group consisting of blueberry, apple, apricot, peach, pear, pumpkin, strawberry, blackberry, grape, cherry, and raspberry crushed fruit and such other fruits as will be obvious to a skilled artisan. The fruit filling base may further include a wheat protein, such as a deamidated wheat gluten, in accordance with the teachings of International Patent Application PCT/US03/01169 (WO 03/061406) which is herein incorporated wholly by reference.

Other layering materials of utility in the present invention may likewise contain a variety of ingredients, which would be obvious to a skilled artisan, including, but not limited to, carbohydrates in the form of mono-, di-, oligo- and polysaccharides, including natural carbohydrate mixtures such as honey, cane syrup, molasses and maple syrup, sugar alcohols and their concentrated solutions, milk, cream, butter, fruits, nuts (including coconut), cocoa, chocolate, gelatine, egg white, fats, oils, gums, pectin, crystallization inhibitors, crystallization modifiers, coloring agents, flavors and aromas.

In one embodiment of the present invention there is provided a layering mass containing protein in the range of about 10 to 55% by weight, with or without the addition of colors, flavors, protein-rich pieces, or other inclusions. In another embodiment, the content of protein is about 10% to about 45% by weight of the mass.

In a further embodiment of the present invention there is provided a fruit or other flavored gelled mass, whereby the gelling may be based on various mechanisms which could include pectin, alginate(s), starch, agar-agar, gelatine, other functional proteins, and their activating agents, (or combinations thereof) which contains an elevated content of protein in the range of 10 to 50%, with or without the addition of colors, flavors, protein rich pieces, or other inclusions. This embodiment also provides a fruit or other flavored gelled mass, which contains an elevated content of protein in the range of 10 to 50% by weight, with or without the addition of colors, flavors, protein rich pieces, or other inclusions, whereby the sugars present have been replaced by one or more sugar alcohols (including glycerine), or poorly digestible sugars such as tagatose, and digestible polysaccharides have been replaced by poorly digestible polysaccharides such as polydextrose.

In a further embodiment of the present invention there is provided a confectionery mass resembling caramel which contains protein, and is made with the addition of digestible sugars, poorly digestible sugars, or sugar alcohols (including glycerine) which contains an elevated content of protein in the range of 18 to 35% by weight.

In yet another embodiment of the present invention, there is provided a fruit-based confectionery mass which contains protein, and is made with the addition of digestable sugars, poorly digestable sugars, or sugar alcohols (including glycerine), whereby the protein content is 18 to 35% by weight, and the fruit may be present in the form of fresh fruit, pureé, powder, concentrate, paste, dried, partially dried, or glaceé fruit, or other suitable forms.

In a further embodiment of the present invention there is provided a confectionery mass based on dried, glaceé, or otherwise preserved, fruit pieces, held in a protein-rich matrix which may also contain digestible sugars, poorly digestible sugars, or sugar alcohols (including glycerine), whereby the mass also contains significant quantities of soluble or insoluble fiber introduced by way of the fruit, pectin, fructo-oligosaccharides, or other materials rich in dietary fiber, and whereby the protein content is 10 to 25% by weight.

Yet another embodiment of the present invention provides a method for manufacture of the novel confectionery layering materials whereby the selected protein in dry powder form and a preformed confectionery mass are introduced into a continuous mixing device which has high efficiency kneading capability and provides a uniform dispersion of the protein throughout the confectionery mass, and which may be heated or cooled as required to maintain internal temperatures within a defined range such that the confectionery mass remains in a viscous liquid state, whereby the residence time in the mixer may be adjusted to the appropriate time for the mixture to achieve the requisite consistency and texture. The mixing device is preferably one which comprises two shafts that may be set to co-rotate, such shafts being configured with paddles and helical screws to both mix and convey the mixture down the barrel without exposing the mixture to high shear conditions. Upon exit from the barrel of the mixer, the novel confectionery layering material may be used directly, or may be discharged into drums for future use.

Yet another embodiment of the present invention provides novel multi-layered nutritional bars wherein one or more layers comprise the novel confectionery layering materials, and wherein such bars may optionally comprise one or more conventional confectionery layers, or one or more high protein layers such as described in U.S. Pat. No. 6,299,929 and U.S. Pat. No. 6,432,457, both of which are herein incorporated in their entirety by reference.

In a preferred embodiment, there is provided a confectionery mass containing protein in the range of 10 to 55% by weight, but preferably in the range of 10 to 45% by weight, with or without the addition of colors, flavors, protein rich pieces, or other inclusions, whereby the carbohydrates present in the white confectionery mass may be digestible carbohydrates, poorly digestible carbohydrates, or mixtures thereof, as well as sugar alcohols, where sugar alcohols as a generic term is deemed to include glycerine.

In another preferred embodiment there is provided a fruit or other flavored gelled mass, based on various gelling mechanisms which may include pectin, alginate(s), starch, agar-agar, gelatine, other functional proteins, and their activating agents, or combinations thereof, which contains protein in the range of 10 to 55% by weight, but preferably in the range of 18 to 35% by weight, with or without the addition of colors, flavors, protein rich pieces, or other inclusions, whereby the carbohydrates present in the high protein gelled mass may be digestible carbohydrates, poorly digestible carbohydrates, or mixtures thereof, as well as sugar alcohols, where sugar alcohols as a generic term is deemed to include glycerine.

In another preferred embodiment there is provided a confectionery mass resembling caramel which contains protein, and is made with the addition of digestible sugars, poorly digestible sugars, or sugar alcohols (including glycerine), which contains an elevated content of protein in the range of 10 to 55% by weight or more preferably in the range of 18 to 35% by weight, whereby the carbohydrates present in the high protein caramel-like mass may be digestible carbohydrates, poorly digestible carbohydrates, or mixtures thereof, as well as sugar alcohols, where sugar alcohols as a generic term is deemed to include glycerine.

In another preferred embodiment there is provided a fruit based confectionery mass comprising fruit in the form of fresh fruit, purée, powder, concentrate, paste, dried, partially dried, or glaceé fruit, or other suitable forms, whereby the mass optionally contains significant quantities of soluble or insoluble fiber introduced by way of the fruit, pectin, fructo-oligosaccharides or other ingredients, the said mass containing elevated levels of protein in the range of 10 to 55% by weight but preferably in the range of 10 to 45% and most preferably in the range of 18 to 35% by weight, whereby the carbohydrates present in the fruit based confectionery mass may be digestible carbohydrates, poorly digestible carbohydrates, or mixtures thereof, as well as sugar alcohols, where sugar alcohols as a generic term is deemed to include glycerine.

Another preferred embodiment of the present invention provides a method for manufacture of the novel confectionery layering materials whereby the selected protein is one or more of a hydrolysed gelatine, a whey protein as isolate or concentrate, or a casein which is optionally in the form of a caseinate, said whey protein or casein optionally being partially hydrolysed but in general, whether unhydrolysed or partially hydrolysed, being denatured to the extent that it is of reduced functionality, yet capable of modifying the crystallization properties of the confectionery mass such that on eventual cooling it will possess a microcrystalline or amorphous structure, in dry powder form and of small particle size, and the preformed confectionery mass is a white or colored confectionery mass, fruit based or gelled fruit mass, or caramel-like mass.

In one embodiment, the selected materials are introduced into a continuous mixing device which has high efficiency and provides a uniform dispersion of the protein throughout the confectionery mass, and which may be heated or cooled as required to maintain internal temperatures within range of 40 to 70° C. such that the confectionery mass remains liquid, such as the Continuous Processors manufactured by Readco Manufacturing Inc., whereby the residence time in the mixer may be adjusted to the appropriate time for the mixture to achieve the requisite uniformity, consistency and texture, such time being generally less than 2 minutes and usually in the range of 30-115 seconds.

The Readco Continuous Processor, or equivalent machine, comprises two shafts that co-rotate, such shafts being configured with paddles and helical screws to both mix and convey the mixture down the barrel within the residence time selected, without exposing the mixture to high shear conditions and with uniform dispersion of the protein material in the liquid confectionery mass. Upon exit from the barrel of the mixer, the novel confectionery layering material is pumped into the reservoir of a slabbing or forming machine and shaped into a layer that may be combined with other layers to give a multilayer confectionery bar with significant nutritional value.

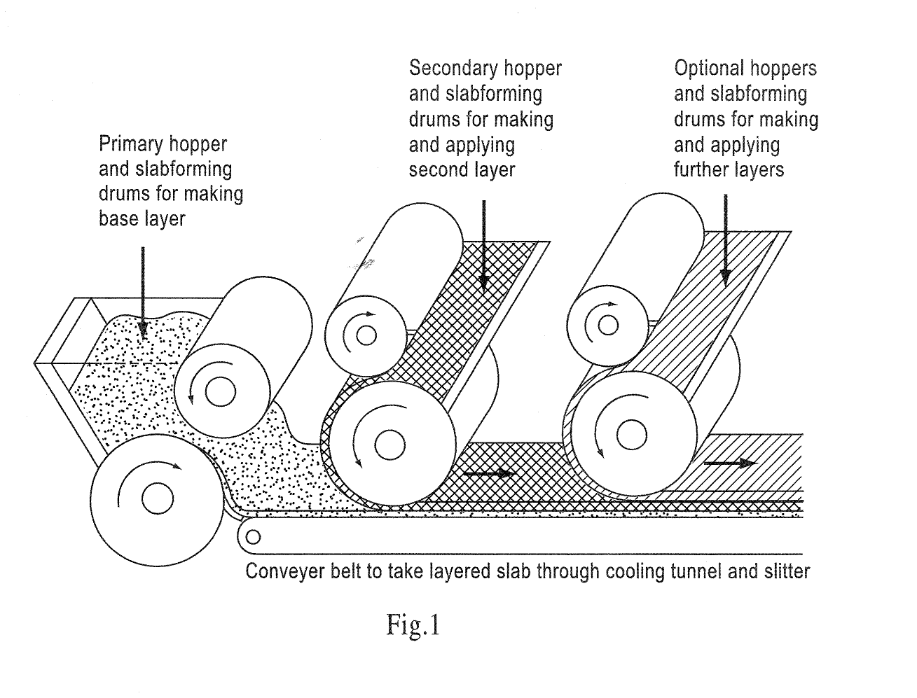

In a preferred configuration of the mixer shown diagrammatically in FIG. 1, the initial processing elements consist of 6 pairs of screws plus one pair of flat paddle blades; this section is called feed section. The actual mixing section consists of five pairs of flat paddle blades and five pairs of forward helical paddles, and the final section is a conveying section consisting of 7 pairs of screws. The specific configuration of mixing elements defines the Theological properties of the finished layering material as it exits the mixer, while the residence or retention time in the mixture may be defined by the feed rate from the function [(mixer volume in cubic feet)/(feed rate in cubic feet/minute)]. Volumes may also be determined in the metric system as litres or cubic meters.

Yet another embodiment of the present invention provides novel nutritional bars, whereby the bars may comprise a single layer of the layering material of the invention, but preferably are two- or multilayered bars wherein one or more layers comprise the layering materials of the invention, and wherein such bars may optionally comprise one or more conventional confectionery layers, or one or more high protein layers such as described in U.S. Pat. No. 6,299,929 and U.S. Pat. No. 6,432,457, both of which are herein incorporated in their entirety by reference. As will be obvious to the skilled artisan, the confectionery layering material according to the invention may in itself be used to manufacture the core of a nutritional bar that may optionally then be enrobed, or to manufacture bite-sized confectionery products resembling candies but of high nutritional content, but it is particularly suited to the manufacture of two- or multilayer bars. The bars of the present invention may be prepared by any method known to the skilled artisan. Such methods include but are not limited to cold extrusion methods.

Suitable “enrobing” materials include coatings that are 20 to 40% fat, most preferably 28 to 35% fat and further comprising a flavor or other substance. The fat may comprise hardened or fractionated vegetable oils. A hardened vegetable oil is a liquid vegetable oil that has been wholly or partially hydrogenated. A fractionated vegetable oil is a vegetable oil such as palm kernel oil that was fairly saturated (and thus relatively solid at room temperature), and which has subsequently been made more saturated either by cooling and pressure-filtering the solid fats out (which then become the fractionated fat), or more often by dissolving in a solvent and cooling, whereby the solid fats crystallize out and may be separated by filtration, again these becoming the fractionated fat.

The flavor of the coating may be chocolate, carob, yoghurt, carrot or fruit or spice flavored. Other coatings are “icings” that are not fat based but comprise sugar with a flavor. Methods for making enrobing materials are known to the skilled artisan and are also commercially available. Chocolate products may be used as enrobing materials, as described above, and are defined in 21 CFR § 163. The FDA describes compound chocolate as “sweet chocolate and vegetable fat coating” or “milk chocolate and vegetable fat coating”. The industry generally refers to these as compound coatings. They differ from “real” chocolate in that they do not contain cocoa butter (though they do contain cocoa powder which may still have some fat in it); it has been replaced by another (hard) vegetable fat or even a stearin made by hydrogenating beef tallow (though that is not usual these days). White confectionery coatings are basically made from a solid vegetable fat (see below), sugar, flavour and milk components such as skim milk powder. Coatings make with yoghurt powder are termed yoghurt-flavored coatings.

In one embodiment, a blend of confectionery materials is prepared in a dough mixer, and mixed until homogenous. A blend of liquids and fats is then made in a liquid mixer, such as a large Hobart mixer and stirring at high speed until homogenous. The liquid blend is then added to the powder blend in the dough mixer and further mixed until a homogenous plastic dough is obtained. This dough is placed in the hopper of a slab former, such as those manufactured by the German company Sollich, and passed between two drums, which may be cooled or warmed as required, and which for convenience may be referred to further in this specification as a “slabbing head”, to form a thin slab of material that is approximately as wide as the drum, for example 30″, though such equipment may be obtained in sizes capable of making slabs from a few inches to several feet wide. This slab is deposited on a moving conveyer belt such that it moves away from the forming drums at a speed corresponding to the rate of formation.

At the same time, the confectionery layering material is warmed, for example from 40° C. to 80° C., and is applied to a third cooled drum (roller) rotating just above the moving slab of dough, such that a thin slab of confectionery layering material is continuously formed at a rate identical to that of the base slab, that can be separated from the drum and caused to adhere to the slab of dough, giving a slab of two layers, namely dough underneath and confectionery layering material on top, whereby the thicknesses of the two layers may be adjusted by firstly adjusting the gap between the drums which form the base layer, and secondly by adjusting the amount of material applied to the third roller, for example, by increasing or decreasing the gap between an optional hopper or a fourth cooled roller and the third roller, or if the material is applied directly from a pump, by adjusting pumping rate.

The composite slab thus prepared is passed through a cooling tunnel, and then slit into ribbons by a set of rotating circular knives, the distance between which defines the width of the eventual bar. These ribbons are subsequently guillotined into bars of the required weight, which may, for example, be about 40 grams each, which are enrobed with a coating material as described above, for example a high protein compound chocolate coating, to give finished bars of about 50 grams, whereby it is understood that the weight and size of the bars are not limiting and may readily be adjusted as required, for example from a few grams upwards, though for general commercial purposes a preferred weight would be in the range of 20 grams to 120 grams.

The bars are then wrapped in a Mylar foil. As will be obvious to a skilled artisan, it is also possible to move the drum that applies the confectionery layering material layer of the invention to a position in front of the confectionery stabbing layer, such that the confectionery layering material layer will eventually become the base layer of the finished bar.

Preferably, the bars of the present invention are two-layer or multi-layer bars in which one of the layers is the confectionery layering material of the invention, whereby any enrobing is not considered as a layer. In one embodiment, multi-layer bars are made according to the process described above, but with additional “slabbing heads” and/or one or more additional drums rotating above the layer of slabbed dough, whereby such drums or “slabbing heads” may be used to apply further layers of confectionery layering material according to the invention or layers of conventional confectionery material, such that further layers are consecutively added to the base slab as it proceeds away from the initial “slabbing head”. In a further embodiment, one or more of the layers may consist of particulate material that is sprinkled onto the slab or composite slab using equipment conventionally known as a nut or seed spreader, and which subsequently may or may not be covered by a further layer. The whole may be exemplified by the diagram of typical equipment configurations shown as FIG. 1.

While the foregoing describes an embodiment whereby the bars according to the invention are manufactured by slab forming, it is also possible to manufacture such items using cold formers known as extruders with specially constructed dies, whereby the various layers are fed simultaneously to dies with internal divisions such that multiple thin “ropes” or strands of layered material are produced that can subsequently by guillotined or cut into bars. Such equipment is manufactured, for example, by the German company Bepex-Hutt, and though it has limited capability for multilayer bars, it offers the capability of creating a bar in which the layers are concentric, that is, the confectionery layering material layer may be surrounded by a concentric layer of confectionery material or vice versa.

### EXAMPLES

The invention is further illustrated by the following examples, without limitation thereto:

### Example 1

A white high-protein confectionery mass was prepared according to the following method, whereby the weights may be scaled up or down in accordance with the quantity of material required but the proportions remain fixed.

Firstly, a liquid preparation was made according to the following formulation, which was mixed in a high shear mixer (such as a Breddo Liquifier or equivalent) until homogenous, and warmed to 40° C.:

| | | |
|---|---|---|
| Maltitol Syrup | 73.99 | kg |
| Soybean Oil | 22.44 | kg |
| Glycerine | 19.21 | kg |
| Sorbitol Syrup 70% | 16.44 | kg |
| Flavors | 4.52 | kg |
| Soy Lecithin | 1.8 | kg |
| Sucralose solution (25%) | 0.37 | kg |
| Mixed Tocopherols | 0.27 | kg |
| Total | 139.04 | kg |

Secondly, a powder blend was prepared by mixing the following ingredients in a horizontal mixer such as a Peerless mixer or equivalent:

| | | |
|---|---|---|
| Gelatine (partially hydrolyzed) | 51.32 | kg |
| Whey protein concentrate (partially hydrolyzed) | 37.22 | kg |
| Calcium caseinate | 37.26 | kg |
| Flavour | 1.8 | kg |
| Total | 127.6 | kg |

The 139.04 kg of liquid and 127.6 kg of powder were metered into a Readco mixer of internal volume 14.187 liters (0.501 cubic feet) in the proportions by weight of 1 part of liquid to 0.918 parts of powder at a rate such that the residence time in the mixer was 100 seconds; this rate was approximately 4.44 kg liquid and 4.03 kg powder per minute. The temperature of the mixer was adjusted to 55° C. A plastic flowable mass was obtained at the exit port and was directly pumped into the 2^{nd} hopper of a multilayer slabformer. The mass had the following nutritional composition:

| NUTRIENT: | CONTENT: | |
|---|---|---|
| Protein | 40.323 | g |
| Carbohydrate, total | 34.281 | g |
| Fat | 9.713 | g |
| Moisture | 11.563 | g |
| Total dietary fibre | 0.000 | g |
| Kilocalories (Atwater) | 381 | Keal |
| Kilojoules | 1 594 | Kj |
| Cholesterol | 23 | mg |
| Saturated fat | 1.707 | g |
| Mono-unsaturated fat | 2.062 | g |
| Poly-unsaturated fat | 5.492 | g |

### Example 2

Firstly, a liquid preparation was made according to the following formulation:

| | | |
|---|---|---|
| Gelatine solution 55% solids | 71.17 | kg |
| Glycerine | 108.60 | kg |
| Maltitol Syrup | 46.27 | kg |
| Monoglycerides (DMG 130) | 2.65 | kg |
| Sucralose solution 25% | 0.67 | kg |
| Water | 4.69 | kg |
| Flavor | 4.88 | kg |
| Calcium Carbonate | 0.85 | kg |
| Mixed tocopherols Dadex GT1 | 0.10 | kg |
| Subtotal | 239.88 | kg |

These liquids were combined in a high shear mixer (such as a Breddo Liquifier or equivalent) and mixed at ambient temperature until homogenous.

Secondly, a powder blend was prepared by mixing the following ingredients in a horizontal mixer such as a Peerless mixer or equivalent:

| | | |
|---|---|---|
| Soy protein isolate (Profam 891) | 57.48 | kg |
| Acid casein | 85.30 | kg |
| Whey protein isolate | 64.34 | kg |
| Gelatine (partially hydrolyzed) | 60.75 | kg |
| Cocoa powder | 12.76 | kg |
| Calcium caseinate | 12.00 | kg |
| Milk minerals | 8.61 | kg |
| Vitamin Premix | 3.58 | kg |
| Flavor | 2.32 | kg |
| Magnesium oxide | 1.42 | kg |
| Fat preparation | 14.74 | kg |
| Subtotal | 323.30 | kg |

The liquid and powder blends were mixed in a horizontal mixer until a homogenous plastic dough resulted. This dough was then fed into the primary hopper of a slabformer, such as made by Sollich, to give a wide slab of a confectionery-type base. The high protein confectionery layering material from Example 1 was pumped into the 2^{nd} hopper of the slabformer and applied as a layer to the confectionery base, whereby the proportions by weight were 1 part confectionery base to 0.473 parts high protein confectionery layer.

The two-layer slab which resulted was passed on a moving belt through a cooling tunnel and slit into strips 3 cm wide, after which the strips were guillotined to a length of about 10.5 cm and enrobed in a compound chocolate coating, to give a nutritional bar of 60 g weight, consisting of 56.3% confectionery base, 26.7% high protein confectionery layering material and 17% compound chocolate coating, with the following nutritional composition:

| NUTRIENT: | CONTENT: | | NUTRIENT: | CONTENT: | |
|---|---|---|---|---|---|
| Protein | 26.133 | g | Carbohydrate, total | 18.878 | g |
| Fat | 5.999 | g | Moisture | 6.477 | g |
| Total dietary fibre | 0.854 | g | Kilocalories | 218 | Kcal |
| Kilojoules | 911 | Kj | (Atwater) | | |
| Saturated fat | 3.744 | g | Cholesterol | 5 | mg |
| Poly-unsaturated fat | 1.208 | g | Mono-unsaturated | 0.723 | g |
| Total omega-6 EFAs | 1.047 | g | fat | | |
| Potassium | 129 | mg | Total omega-3 EFAs | 0.157 | g |
| Calcium | 266 | mg | Linoleic acid | 1.047 | g |
| Vitamin A | 1515 | IU | Sodium | 114 | mg |
| Vitamin E | 11.803 | IU | Phosphorus | 229 | mg |
| Thiamine | 0.476 | mg | Vitamin D | 0 | IU |
| Niacin | 6.080 | mg | Vitamin C | 18.115 | mg |
| Vitamin B12 | 2.459 | mcg | Riboflavin | 0.578 | mg |
| Biotin | 90 | mcg | Vitamin B6 | 0.601 | mg |
| Iron | 6.599 | mg | Folate | 126 | mcg |
| Magnesium | 40 | mg | Pantothenate | 3.028 | mg |
| Zinc | 5.049 | mg | Iodine | 47 | mcg |
| | | | Copper | 0.708 | mg |
| | | | Manganese | 0.624 | mg |

### Example 3

In the following example, all figures are given as percentages of the final product, and may be scaled to meet requirements, for example, by 10 times the numerical figures to give a kg mix size. The example illustrates the manufacture of a novel two-layer bar with a chocolate-flavored base and a high protein strawberry-flavored topping, the whole enrobed in a compound chocolate-flavored coating.

The base was prepared by mixing liquid and powder blends to give a dough.

Firstly, a powder preparation was made according to the following formulation:

| | |
|---|---|
| Acid casein | 8.530 |
| Whey protein isolate | 6.434 |
| Gelatine (hydrolyzed) | 6.075 |
| Soy protein concentrate | 5.748 |
| Cocoa 10/12% fat, alkali process | 0.491 |
| Calcium caseinate | 1.200 |
| Milk minerals | 0.861 |
| Cocoa 10/12%, black | 0.785 |
| Vitamin and mineral premix | 0.358 |
| Flavour | 0.232 |
| Magnesium oxide | 0.142 |
| Magnasweet (licorice extract) | 0.019 |
| Total | 30.875 |

The powder blend was prepared by mixing the above ingredients in a horizontal mixer such as a Peerless mixer or equivalent:

| | |
|---|---|
| Gelatine solution 55% | 7.117 |
| Glycerine | 10.86 |
| Maltitol syrup | 4.489 |
| Fat preparation | 0.896 |
| Chocolate liquor | 0.715 |
| Water | 0.519 |
| Flavour | 0.394 |
| Monoglycerides | 0.265 |
| Cocoa extract | 0.094 |
| Calcium carbonate | 0.085 |
| Sucralose. | 0.017 |
| Mixed tocopherols | 0.010 |
| Total | 25.461 |

The above liquids were combined in a high shear mixer (such as a Breddo Liquifier or equivalent) and mixed at ambient temperature until homogenous

The liquid and powder blends were mixed in a horizontal mixer until a homogenous plastic dough resulted, which was identified as P742 dough.

A strawberry high protein topping was then prepared as follows. Firstly, a liquid preparation was made according to the following formulation, which was mixed in a high shear mixer (such as a Breddo Liquifier or equivalent) until homogenous, and warmed to 40° C.:

| | |
|---|---|
| Maltitol syrup | 9.291 |
| Strawberry Juice Conc. | 2.980 |
| Sugar | 1.753 |
| Glycerine | 1.315 |
| Sorbitol | 0.906 |
| Water | 0.845 |
| Citric Acid 50% soln | 0.533 |
| Palm Kernel oil | 0.350 |
| Pectin | 0.219 |
| Sodium Citrate | 0.066 |
| Sucralose | 0.012 |
| Natural Flavour | 0.009 |
| Lecithin | 0.008 |
| Colour (Red 40) | 0.002 |
| Total | 18.29 |

The above liquid blend except the citric acid 50% solution was heated to 75° C. in a Groen kettle and then the citric acid solution was added at that temperature.

Secondly, a powder blend was prepared by mixing the following ingredients in a horizontal mixer such as a Peerless mixer or equivalent:

| | |
|---|---|
| Whey Protein Isolate | 7.998 |
| Monoglycerides DMG 130 | 0.325 |
| Flavour | 0.053 |
| Water | 0.002 |
| Sucralose | 0.001 |
| Total | 8.377 |

The 18.29 parts of liquid and 8.38 parts of powder were metered into the mixer (Readco) in the proportion of 1 part of liquid to 0.458 parts of powder at a rate such that the residence time in the mixer was 90 seconds. The temperature of the mixer was adjusted to 40° C. A plastic strawberry-flavored flowable mass was obtained at the exit port and identified as P742 topping. The nutritional composition of this topping was:

| NUTRIENT: | CONTENT: | |
|---|---|---|
| Protein | 27.925 | g |
| Carbohydrate, total | 55.673 | g |
| Fat | 2.399 | g |
| Moisture | 14.670 | g |
| Total dietary fibre | 0.906 | g |
| Kilocalories (Atwater) | 312 | Kcal |
| Kilojoules | 1305 | Kj |
| Cholesterol | 3 | mg |
| Saturated fat | 1.354 | g |
| Mono-unsaturated fat | 0.279 | g |
| Poly-unsaturated fat | 0.600 | g |

The P742 dough was then fed into the primary hopper of a slabformer, such as made by Sollich, to give a wide slab of a confectionery-type base. The P742 topping was pumped into the 2^{nd} hopper of the slabformer and applied as a layer to the confectionery base, whereby the proportions by weight were 1 part confectionery base to 0.473 parts high protein confectionery layer.

The two-layer slab which resulted was passed on a moving belt through a cooling tunnel and slit into strips 3 cm wide, after which the strips were guillotined to a length of about 10.5 cm and enrobed in a compound chocolate coating, to give a nutritional bar of 60 g weight, consisting of 56.3% confectionery base, 26.7% high protein confectionery layering material and 17% compound chocolate coating, with the following nutritional composition:

| NUTRIENT: | CONTENT: | | NUTRIENT: | CONTENT: | |
|---|---|---|---|---|---|
| Protein | 24.068 | g | Carbohydrate, total | 22.298 | g |
| Fat | 4.899 | g | Moisture | 6.902 | g |
| Total dietary | 0.999 | g | Kilocalories | 212 | Kcal |
| fiber | | | (Atwater) | | |
| Kilojoules | 887 | Kj | Cholesterol | 2 | mg |
| Saturated fat | 3.705 | g | Mono-unsaturatedfat | 0.467 | g |
| Poly-unsaturated | 0.450 | g | Total omega-3 | 0.061 | g |
| fat | | | EFAs | | |
| Total omega-6 | 0.389 | g | Linoleic | 0.389 | g |
| EFAs | | | acid | | |
| Potassium | 98 | mg | Sodium | 122 | mg |
| Calcium | 231 | mg | Phosphorus | 202 | mg |
| Vitamin A | 1504 | IU | Vitamin D | 1 | IU |
| Vitamin E | 9.803 | IU | Vitamin C | 18.188 | mg |
| Thiamine | 0.466 | mg | Riboflavin | 0.557 | mg |
| Niacin | 6.076 | mg | Vitamin B6 | 0.601 | mg |
| Vitamin B12 | 2.222 | mcg | Folate | 126 | mcg |
| Biotin | 90 | mcg | Pantothenate | 3.028 | mg |
| Iron | 6.557 | mg | Iodine | 45 | mcg |
| Magnesium | 38 | mg | Copper | 0.708 | mg |
| Zinc | 4.938 | mg | Manganese | 0.624 | mg |

### Example 4

In the following example, all figures are given as parts by weight of the final product, and may be scaled to meet requirements, for example, by 10 times the numerical figures to give a kg mix size. The example illustrates the manufacture of a novel sugar-free caramel. The initial step was to obtain a “no sugar” caramel base, which was prepared as follows.

Firstly, a homogenized milk protein blend was prepared by placing the following ingredients in a tank equipped with a high shear mixer and a method of heating, such as heating elements. The blend was then heated to approximately 140° C. with mixing, and further mixed at this temperature until homogenous. For a batch of about 200 litres this took 15 to 25 minutes. Alternatively, the hot mix could be passed through a homogenizer such as those supplied by Manton Gaulin or Alfa Laval.

| | |
|---|---|
| Water | 10.80 |
| Hydrogenated palm kernel oil | 4.00 |
| Calcium caseinate | 4.00 |
| Whey protein isolate | 1.00 |
| Soya lecithin | 0.20 |
| Total | 20.00 |

Secondly, 20 parts by weight of the homogenized milk protein blend was mixed with the following ingredients in the indicated parts by weight in a kettle designed for boiling caramel:

| | |
|---|---|
| Maltitol syrup 75% solids | 48.00 |
| Homogenized milk preparation from above | 20.00 |
| Oligofructose powder | 30.80 |

Heat was applied with stirring, and the mixture was boiled to 85%-87% solids; boiling occurred at approximately 110° C. Once reduced to the targeted solids level, heating was stopped and 1.00 parts by weight of glyceryl monostearate was mixed in. The mixture was allowed to cool further to <80° C., whereupon 0.20 parts by weight of flavor was blended in. Upon completion and a short period of further mixing to ensure dispersion of the flavor, the caramel base was cooled to approximately 50° C. and held for use in the preparation of a novel high protein caramel. To prepare this novel high protein confectionery layering material of caramel type, the caramel base at 50° C. was metered into the mixer (Readco) with a whey protein isolate in the proportion of 4 parts of liquid caramel base to 1 part of whey protein isolate, at a rate such that the residence time in the mixer was 100 seconds. The temperature of the mixer was adjusted to 45° C. A plastic flowable high protein caramel was obtained at the exit port and packed off in drums. The nutritional composition of this caramel was:

| NUTRIENT: | CONTENT: | |
|---|---|---|
| Protein | 22.756 | g |
| Carbohydrate, total | 59.981 | g |
| Of which: | | |
| Soluble fibre | 25.431 | g |
| Insoluble fibre | 0.000 | g |
| Sugars | 1.635 | g |
| Sugar alcohols | 32.907 | g |
| Other carbohydrate | 0.009 | g |
| Fat | 4.731 | g |
| Moisture | 12.042 | g |
| Total dietary fibre | 25.431 | g |
| Kilocalories (Atwater) | 296 | Kcal |
| Kilojoules | 1241 | Kj |
| Cholesterol | 2 | mg |
| Saturated fat | 3.342 | g |
| Mono-unsaturated fat | 0.469 | g |
| Poly-unsaturated fat | 0.562 | g |

### Example 5

A further novel high protein caramel was made in accordance with the procedure of Example 4. All figures are given as parts by weight of the final product, and may be scaled to meet requirements, for example, by 10 times the numerical figures to give a kg mix size. The initial step was to obtain a caramel base, which was prepared as follows.

Firstly, a homogenized milk blend was prepared by placing the following ingredients in a tank equipped with a high shear mixer and a method of heating, such as heating elements. The blend was then heated to approximately 130° C. with mixing, and further mixed at this temperature until homogenous. For a batch of about 200 litres this took 15 to 25 minutes. Alternatively, the hot mix could be passed through a homogenizer such as those supplied by Manton Gaulin or Alfa Laval.

| | |
|---|---|
| Water | 16.20 |
| Skim milk | 7.50 |
| powder | |
| Fractionated palm kernel | 6.00 |
| oil | |
| Soya lecithin | 0.30 |
| Total | 30.00 |

Secondly, 30 parts by weight of the homogenized Bilk blend was mixed with 40 parts by weight of a 42 DE Corn syrup and 28.80 parts by weight of granulated sugar in a kettle designed for boiling caramel. Heat was applied with stirring, and the mixture was boiled to 85%-87% solids; boiling occurred at approximately 110° C. Once reduced to the targeted solids level, heating was stopped and 1.00 parts by weight of glyceryl monostearate was mixed in. The mixture was allowed to cool further to <80° C., whereupon 0.20 parts by weight of flavor was blended in. Upon completion and a short period of further mixing to ensure dispersion of the flavor, the caramel base was cooled to approximately 50° C. and held for use in the preparation of a novel high protein caramel. To prepare this novel high protein confectionery layering material of caramel type, the caramel base at 50° C. was metered into the mixer (Readco) with a whey protein isolate in the proportion of 4 parts of liquid caramel base to 1 part of whey protein isolate, at a rate such that the residence time in the mixer was 100 seconds. The temperature of the mixer was adjusted to 45° C. A plastic flowable high protein caramel was obtained at the exit port and packed off in drums. The nutritional composition of this caramel was:

| NUTRIENT: | CONTENT: | |
|---|---|---|
| Protein | 17.995 | g |
| Carbohydrate, total | 61.955 | g |
| Of which: | | |
| Soluble fibre | 0.000 | g |
| Insoluble fibre | 0.000 | g |
| Sugars | 43.908 | g |
| Sugar alcohols | 0.000 | g |
| Other carbohydrate | 18.406 | g |
| Fat | 6.841 | g |
| Moisture | 11.819 | g |
| Total dietary fibre | 0.000 | g |
| Kilocalories (Atwater) | 378 | Kcal |
| Kilojoules | 1584 | Kj |
| Cholesterol | 2 | mg |
| Saturated fat | 5.057 | g |
| Mono-unsaturated fat | 0.616 | g |
| Poly-unsaturated fat | 0.642 | g |

### Example 6

In the following example, all figures are given as percentages of the final product, and may be scaled to meet requirements, for example, by 10 times the numerical figures to give a kg mix size. The example illustrates the manufacture of a novel two-layer bar with a chocolate-flavored base and a high protein strawberry-flavored topping, the whole enrobed in a compound chocolate-flavored coating.

The base was prepared by mixing liquid and powder blends to give a dough.

Firstly, a liquid preparation was made according to the following formulation:

| | |
|---|---|
| Gelatine solution 55% | 7.119 |
| Glycerine | 9.663 |
| Maltitol syrup | 6.401 |
| Flavour | 0.485 |
| Mono and diglycerides | 0.175 |
| Mixed tocopherols | 0.010 |
| Water | 0.010 |
| Sucralose | 0.003 |
| Subtotal | 23.866 |

These liquids were combined in a high shear mixer (such as a Breddo Liquifier or equivalent) and mixed at ambient temperature until homogenous.

Secondly, a powder blend was prepared by mixing the following ingredients in a horizontal mixer such as a Peerless mixer or equivalent:

| | |
|---|---|
| Acid casein | 8.104 |
| Whey protein isolate | 7.333 |
| Gelatine zero bloom | 6.076 |
| Soy protein concentrate | 5.749 |
| Calcium caseinate | 1.630 |
| Special fat preparation | 1.475 |
| Milk mineral concentrate | 1.190 |
| Vitamin and mineral premix | 0.330 |
| Flavour | 0.316 |
| Magnesium oxide | 0.206 |
| Licorice root extract | 0.053 |
| Subtotal | 32.462 |

The liquid and powder blends were mixed in a horizontal mixer until a homogenous plastic dough resulted, which was identified as P779 dough.

An apple-based high protein topping was then prepared as follows. Firstly, a liquid preparation was made according to the following formulation, which was mixed in a high shear mixer (such as a Breddo Liquifier or equivalent) until homogenous, and warmed to 40° C.:

| | |
|---|---|
| Water | 0.933 |
| Whey protein isolate | 0.093 |
| Monoglycerides | 0.089 |
| Lecithin | 0.065 |
| Mixed tocopherols | 0.010 |
| Soybean oil | 1.385 |
| Maltitol syrup | 7.895 |
| Glycerol | 1.725 |
| Sorbitol Syrup | 0.543 |
| Flavour | 0.586 |
| Caramel colour | 0.312 |
| Subtotal | 13.636 |

Secondly, a powder blend was prepared by mixing the following ingredients in a horizontal mixer such as a Peerless mixer or equivalent:

| | |
|---|---|
| Whey protein concentrate (partially hydrolyzed) | 2.657 |
| Whey protein isolate | 3.718 |
| Apple powder | 4.851 |
| Soy protein isolate | 1.568 |
| Malic acid | 0.207 |
| Flavour | 0.031 |
| Subtotal | 13.032 |

The 13.636 parts of liquid and 13.032 parts of powder were metered into the mixer (Readco) in the proportion of 1 part of liquid to 0.956 parts of powder at a rate such that the residence time in the mixer was 90 seconds. The temperature of the mixer was adjusted to 40° C. A plastic apple-based flowable mass was obtained at the exit port and identified as P779 topping. The nutritional composition of this topping was:

| NUTRIENT: | CONTENT: | |
|---|---|---|
| Protein | 26.451 | g |
| Carbohydrate, total | 48.966 | g |
| Of which: | | |
| Soluble fibre | 1.019 | g |
| Insoluble fibre | 2.632 | g |
| Sugars | 11.383 | g |
| Sugar alcohols | 29.974 | g |
| Other carbohydrate | 3.958 | g |
| Fat | 6.881 | g |
| Moisture | 13.808 | g |
| Total dietary fibre | 3.652 | g |
| Kilocalories (Atwater) | 353 | Kcal |
| Kilojoules | 1478 | Kj |
| Cholesterol | 18 | mg |
| Saturated fat | 1.291 | g |
| Mono-unsaturated fat | 1.403 | g |
| Poly-unsaturated fat | 3.855 | g |

The P779 dough was then fed into the primary hopper of a slabformer, such as made by Sollich, to give a wide slab of a confectionery-type base.

The P779 topping was pumped into the 2^{nd} hopper of the slabformer and applied as a layer to the confectionery base, whereby the proportions by weight were 1 part confectionery base to 0.473 parts high protein confectionery layer.

The two-layer slab which resulted was passed on a moving belt through a cooling tunnel and slit into strips 3 cm wide, after which the strips were guillotined to a length of about 10.5 cm and enrobed in a compound chocolate coating, to give a nutritional bar of 60 g weight, consisting of 56.3% confectionery base, 26.7% high protein confectionery layering material and 17% compound chocolate coating, with the following nutritional composition:

| NUTRIENT: | CONTENT: | | NUTRIENT: | CONTENT: | |
|---|---|---|---|---|---|
| Protein | 28.168 | g | Carbohydrate, total | 24.786 | g |
| Fat | 6.283 | g | Moisture | 7.840 | g |
| Total dietary | 0.282 | g | Kilocalories | 248 | Kcal |
| fibre | | | (Atwater) | | |
| Kilojoules | 1039 | Kj | Cholesterol | 5 | mg |
| Saturated | 3.873 | g | Mono-unsaturated | 0.760 | g |
| fat | | | fat | | |
| Poly-unsaturated | 1.223 | g | Total omega-3 | 0.178 | g |
| fat | | | EFAs | | |
| Total omega-6 | 1.042 | g | Linoleic | 1.042 | g |
| EFAs | | | acid | | |
| Potassium | 121 | mg | Sodium | 160 | mg |
| Calcium | 303 | mg | Phosphorus | 237 | mg |
| Vitamin A | 1765 | IU | Vitamin D | 0 | IU |
| Vitamin E | 12.221 | IU | Vitamin C | 21.464 | mg |
| Thiamine | 0.542 | mg | Riboflavin | 0.657 | mg |
| Niacin | 7.020 | mg | Vitamin B6 | 0.706 | mg |
| Vitamin B12 | 2.643 | mcg | Folate | 141 | mcg |
| Biotin | 105 | mcg | Pantothenate | 3.548 | mg |
| Iron | 6.751 | mg | Iodine | 54 | mcg |
| Magnesium | 47 | mg | Copper | 0.700 | mg |
| Zinc | 5.777 | mg | Manganese | 0.700 | mg |

### REFERENCES

Each of these references is herein incorporated by reference.
Koc, A. B.; Heinemann, P. H. and Ziegler, GR. (2003) A process for increasing the free fat content of spray-dried whole milk powder. Journal of Food Science 68 (1):210-216
Roos, Y. H (1998) Role of water in phase transition phenomenon in foods. In Rao, M A, Hartel R W, edited. Phase/state transition in foods. New York: Marcel-Dekker Inc. p 57-86
Uthayakumaran, S. Newberry, M. Keentok, M. Stoddard, F. L. Bekes, F. Basic rheology of bread dough with modified protein content and glutenin-to-gliadin ratios. [Journal article] Cereal Chemistry. [St. Paul, Minn.: American Association of Cereal Chemists, 1924-] November/December 2000. v. 77 (6) p. 744-749.
Holt, C. McPhail, D. Nylander, T. Otte, J. Ipsen, R. H. Bauer, R. Ogendal, L. Olieman, K. Kruif, K. G. de. Leonil, J. Some physico-chemical properties of nine commercial or semi-commercial whey protein concentrates, isolates and fractions. [Journal article] International Journal of Food Science & Technology. [Oxford: Blackwell Scientific Ltd] October/December 1999. v. 34 (5/6) p. 587-601.
Kenny, S. Wehrle, K. Stanton, C. Arendt, E. K. Incorporation of dairy ingredients into wheat bread: effects on dough rheology and bread quality. [Journal article] European Food Research & Technology. [Berlin: Springer, c1999-] 2000. v. 210 (6) p. 391-396
Rha, C. K. Pradipasena, P. Viscosity of proteins. [Book chapter] Functional properties of food macromolecules/edited by J. R. Mitchell and D. A. Ledward. London: Elsevier Applied Science Publishers, 1985. ill. p. 79-120.
Barton, Allan F. M., handbook of Solubility Parameters and other cohesion parameters., Boca Raton, Fla.: CRC Press Inc. 1983.
Lynch, William R., Smith; Larry D., Wiant, Matthew J., Bianca, Robert R. and Kelley, Jr., David, 1995, U.S. Pat. No. 5,384,148, Caramel confections and processes for preparing and using.

What we claim is:

1. A homogenous layering mass comprising carbohydrate and protein, wherein 10% to 55% by weight of said layering mass is protein, wherein the protein is in non-particulate form and uniformly dispersed throughout the mass; wherein said carbohydrate is in the form of a concentrated liquid or in dry form with the addition of water; and wherein said layering mass is a flowable, viscous liquid at temperatures of 40° C. or above but is non-flowable, with good stand-up behavior at temperatures of 30° C. or less.

2. The layering mass of claim 1, comprising 10% to 50% by weight of said protein.

3. The layering mass of claim 1, comprising 10% to 45% by weight of said protein.

4. The layering mass of claim 1, comprising 20% to 45% by weight of said protein.

5. The layering mass of one of claims 1-4, which comprises fruit and a gelling agent.

6. The layering mass of claim 5, wherein said gelling agent is selected from the group consisting of pectin, alginate, starch, agar-agar, gelatine and mixtures thereof.

7. The layering mass of claim 5, wherein said fruit is selected from the group consisting of fresh fruit, dried fruit, fruit puree, powdered fruit, concentrated fruit, partially dried fruit, glacéed fruit and combinations thereof.

8. The layering mass of claim 7, wherein said protein is selected from the group consisting of a whey protein concentrate, a whey protein isolate, caseinate, wheat protein, casein, gelatine, soy protein, pea protein and mixtures thereof

9. The layering mass of claim 8, wherein said protein is whey protein in which up to 50% of the protein is hydrolyzed.

10. The layering mass of claim 1, wherein said carbohydrate is partially or wholly a sugar alcohol, wherein said sugar alcohol is selected from the group consisting of glycerine, sorbitol, maltitol, lactitol, hydrogenated starch hydrolysate, erythritol, xylitol, arabinitol, galactitol, isomaltitol, palatinit, mannitol ribitol and mixtures thereof.

11. The layering mass of claim 1, which further comprises another ingredient selected from the group consisting of a preservative, flavor, color, protein in particulate form, vitamins, minerals, nutritional additives and combinations thereof.

12. The layering mass of claim 1, which is caramel.

13. The layering mass of claim 12, wherein said protein is selected from the group consisting of a whey protein concentrate, a whey protein isolate, caseinate, wheat protein, casein, gelatine, soy protein, pea protein and mixtures thereof.

14. The layering mass of claim 13, wherein said protein is whey protein in which up to 50% of the protein is hydrolyzed.

15. The layering mass of claim 12, wherein said caramel further comprises oil or fat.

16. The layering mass of claim 15, wherein said caramel further comprises at least one ingredient selected from the group consisting of nuts, seeds, legumes, lecithin, flavor, preservatives, nutritional additives and color.

17. The layering mass of claim 13, wherein said caramel comprises deamidated wheat protein.

18. The layering mass of claim 12, wherein 18 to 35% by weight of said caramel is protein.

19. The layering mass of claim 1, which is a confectionery material selected from the group consisting of creams, taffy, fondants, fudges, marshmallow, nougat, gummy layering materials and jellies.

20. The layering mass of claim 1, which is in the form of a bar.

21. A bar comprising at least two layers of confectionery mass, wherein at least one of said layers is a conventional confectionery mass and at least one of said layers is a layering mass of claim 1.

22. The layering mass of claim 20, wherein said bar is bite-sized.

23. The layering mass of claim 20, wherein said bar is a nutritional bar.

24. The layering mass of claim 20, which is enrobed in a coating material.

25. The layering mass of claim 24, wherein said coating material is selected from the group consisting of flavored fat, flavored sugar, chocolate, white chocolate, compound chocolate, yoghurt-flavored coatings, white confectionery coatings, and carob-based coating.

26. The layering mass of claims 25, wherein the fat comprises cocoa butter, cocoa butter equivalents, or cocoa butter substitutes.

27. The layering mass of claim 25, wherein said fat comprises hardened or fractionated vegetable oils.

28. The layering mass of claim 24, wherein at least 20% of the total weight of the coating is fat and the coating further comprises at least one other ingredient selected from the group consisting of cocoa powder, chocolate liquor, yoghurt powder, carob powder, carbohydrates, emulsifiers and flavors.

29. The layering mass of claim 1 comprising maltitol syrup, soybean oil, glycerine, sorbitol syrup, flavors, soy lecithin, sucralose solution, mixed tocopherols, gelatine, whey protein concentrate, and calcium caseinate.

30. The layering mass of claim 1, comprising gelatine, glycerine, maltitol syrup, monglycerides, sucralose solution, water, flavor, calcium carbonatR, mixed tocopherols, soy protein isolate, acid casein, whey protein isolate, gelatine, cocoa powder, calcium caseinate, milk minerals, vitamins, magnesium oxide, and fat.

31. The layering mass of claim 1, comprising acid casein, whey protein isolate, gelatine, soy protein concentrate, cocoa, calcium caseinate, milk minerals, vitamins, minerals, flavor, magnesium oxide, magnasweet, glycerine, maltitol syrup, fat, chocolate liquor, water, monoglycerides, calcium carbonate, sucralose, and tocopherols.

32. The layering mass of claim 1, comprising maltitol syrup, strawberry juice concentrate, sugar, glycerine sorbitol, water, palm kernel oil, pectin sodium citrate, sucrolose flavor, lecithin color, whey protein isolate, citric acid, and monoglycerides.

33. The layering mass of claim 1, comprising water, hydrogenated palm kernel oil, calcium caseinate, whey protein isolate, soya lecithin, maltitol syrup, oligofructose and glyceryl monostearate.

34. The layering mass of claim 1, comprising water, skim milk powder, fractionated palm kernel oil, soya lecithin, corn syrup, granulated sugar, glyceryl monostearate, and flavor.

35. The layering mass of claim 1, comprising gelatine, glycerine, maltitol syrup, flavor, monoglycerides, diglycerides, tocopherols, water, sucralose, acid casein, whey protein isolate, soy protein concentrate, calcium caseinate, fat, milk mineral concentrate, vitamins, minerals, magnesium oxide and licorice root extract.

36. The layering mass of claim 1, comprising water, whey protein isolate, monoglycerides, lecithin, tocopherols, soybean oil, maltitol syrup, glycerol, sorbitol syrup, flavor, caramel color, whey protein concentrate, apple powder, soy protein isolate, and malic acid.

37. A method of making a layering mass, the method comprising
(a) combining protein and carbohydrate to form a mass;
(b) mixing the mass so as to uniformly disperse the protein throughout the mass; and
(c) maintaining the internal temperature of the mass at a temperature such that the mass is in a viscous, flowable state capable of forming a layer;
wherein at least 10% to 55% by weight of the layering mass is protein and wherein said carbohydrate is in liquid concentrated form or is in dry form mixed with water.

38. The method of claim 37, further comprising lowering said internal temperature of the product of part (c) so as to produce a mass that is non-flowable and has good stand-up behavior.

39. The method of claim 37, wherein the internal temperature of part (c) is at least 40° C.

40. The method of making a bar comprising the steps of:
(a) providing the layering mass of claim 1;
(b) providing a conventional confectionery mass;
(c) forming a slab from said layering mass;
(d) forming a slab from said conventional confectionery mass;
(e) layering said layering mass slab on said conventional confectionery slab; and
(f) cutting said layered slabs into a bar.

41. A method of making a bar comprising the steps of:
(a) providing the layering mass of claim 1;
(b) forming a slab from (a);
(c) cutting the slab of (b) into a bar.

42. The method of claim 41 further comprising enrobing the bar of part (c) with a coating.
